(19) United States
(12) Patent Application Publication
(10) Pub. No.: US 2002/0059627 A1
(43) Pub. Date: May 16, 2002

(54) Agent-enabled real-time quality of service system for audio-video media

(76) Inventors: Farhad Fuad Islam, Marsfield (AU); Junichi Yamazaki, Atsugi-shi (JP)

Correspondence Address: HEWLETT-PACKARD COMPANY, Intellectual Property Administration, P. O. Box 272400, Fort Collins, CO, 80527-2400, US

(21) Appl. No.: 09/892,289

(22) Filed: Jun. 26, 2001

Related U.S. Application Data
(63) Continuation of application No. 08/978,795, filed on Nov. 26, 1997, now abandoned.

(30) Foreign Application Priority Data
Nov. 27, 1996 (JP) 08-316124

(51) Int. Cl. H04N 7/173

(52) U.S. Cl. 725/96

(57) ABSTRACT

An end device that includes an operating system that controls media manipulation is controlled to provide a quality of service specified by a user. An input specifying a demand for a quality of service is received. The quality of service provided is monitored to determine whether the quality of service provided meets the quality of service demanded. When the quality of service provided is less than the quality of service demanded, a software agent is used to assert dynamic control over the operating system to increase resources allocated to the media manipulation to improve the quality of service provided. A system includes an end device adapted to provide a quality of service specified by a user. The end device comprises an operating system, resources that operate in response to the operating system to perform tasks including media manipulation, and an input device. The input device is configured to receive parameters specifying a demand for a quality of service. The end device also includes monitor that monitors a quality of service provided to determine whether the quality of service provided meets the quality of service demanded. Finally, the end device includes a software agent that operates in response to the monitor and that, when the quality of service provided is less than the quality of service demanded, asserts dynamic process control over the operating system to increase an allocation of the resources to performing the media manipulation to improve the quality of service provided.

### FIELD OF THE INVENTION

The invention relates to a control system that uses software agents located in end devices connected to a network or in stand-alone end devices to improve the video and audio quality in the end devices. Specifically, the invention relates to an agent-enabled control system that operates to improve the video quality and audio quality in response to video quality and audio quality demands established by the user.

### BACKGROUND OF THE INVENTION

Multimedia network systems have a variety of applications including video conferencing and bidirectional communication. In such applications, information signals are exchanged between end devices connected to the network. However, the end devices connected to the network often have different performance capabilities. Consequently, the quality of the video and audio reproduced by the end devices may be less than that desired by the user. Taking video conferencing as an example, as the number of conference participants increases, the number of end devices exchanging information signals increases. The increasing number of information signals increases the load on the network. The more the load on the network increases, the more the quality of the video and audio reproduced by the end devices worsens. One primary source of quality degradation is the load on the network itself. If the load on the network exceeds the capacity of the network, the smooth presentation of the video conference may be disrupted, which could be frustrating for the participants.

When video and audio reproduction is one of a number of tasks performed by a stand-alone system, the quality of the video and audio may be degraded when some of the system resources required to provide good video and audio quality are taken away to perform other tasks.

Some of the factors that determine video quality will be described next. The factors determining the quality of the video reproduction may be described by parameters such as the number of quantizing levels with which the video signal is encoded, the frame rate of the video signal, and the picture size expressed in terms of number of pixels in the horizontal and vertical directions. The number of quantizing levels determines the grey-scale resolution of the picture. The frame rate determines the smoothness of motion in the video.

Sometimes the user may wish to change one or more of these parameters based on the user's purpose for using the network or on the user's preferences. For example, when the display displays a video picture in each of multiple windows, the user may wish to establish specific viewing conditions for one or more of the windows. In a video conference, for example, the user may wish to establish a large, high-resolution window with which to view the conference chair person. However, this window may have a relatively low frame rate. On the other hand, the user may wish to observe changes in the facial expression of a particular speaker by establishing a window in which the video has a high frame rate. However, this window may be relatively small and may have relatively few pixels in the horizontal and vertical directions. In a surveillance monitor system capable of monitoring many locations, the user may have the need to see a large, clear picture even if the video has a slow frame rate. Alternatively, the user may have the need to accurately monitor changes at a location using a relatively small picture with a fast frame rate.

Previously, hardware improvements were used to address these problems. Such solutions as speeding up the processing speed of the CPU, installing more memory, installing improving signal compression and expansion boards, and installing more co-processors, etc. have been tried. Although hardware improvements are effective at solving these problems, they are costly and inefficient. Increasing the processor speed may require that the entire computer be replaced. There are also problems in terms of time since hardware improvements cannot always be immediately installed when needed. In applications in which low-speed operation is usually adequate, and in which high-speed operation is needed only during video conferencing, it may be inefficient to invest in hardware that is only needed when the system is used for video conferencing.

If video is generated in a stand-alone end device or in a multimedia network system such as a video conferencing system or a bidirectional communication system, when the load on the system increases, the video and audio quality demanded by the user may not be attained. Taking video conferencing as an example, as the number of participants increases and the number of pictures displayed increases, the picture quality may drop as a result of the end device being heavily loaded by the need to perform a large amount of media processing. What is needed in situations like this is the ability to upgrade the overall video and audio quality to a minimum acceptable level or at least the ability to improve and maintain the quality of a specific picture of the user's choice.

### SUMMARY OF THE INVENTION

The invention provides a method of controlling an end device that includes an operating system that controls media manipulation to provide a quality of service specified by a user. In the method, an input specifying a demand for a quality of service is received. The quality of service provided is monitored to determine whether the quality of service provided meets the quality of service demanded. When the quality of service provided is less than the quality of service demanded, a software agent is used to assert dynamic control over the operating system to increase resources allocated to the media manipulation to improve the quality of service provided.

The end device may be connected to a network to which an additional end device is connected. In this case, the quality of service perceived by the user of the end device depends on media signals sent by the additional end device, the software agent is used to issue instructions to the additional end device, and a further software agent located in the additional end device is used to perform a bit rate control operation in response to the instructions issued by the software agent. The bit rate control operation improves the quality of service provided at the end device.

The software agent may causes the operating system to increase resources allocated to the media manipulation by ways that include changing the priority level of the media manipulation and increasing CPU time allocated to the media manipulation.

The invention also provides a system that includes an end device adapted to provide a quality of service specified by a user. The end device comprises an operating system, resources that operate in response to the operating system to perform tasks including media manipulation, and an input device. The input device is configured to receive parameters specifying a demand for a quality of service. The end device also includes a quality of service monitor that monitors a quality of service provided to determine whether the quality of service provided meets the quality of service demanded. Finally, the end device includes a software agent that operates in response to the quality of service monitor and that, when the quality of service provided is less than the quality of service demanded, asserts dynamic process control over the operating system to increase an allocation of the resources to performing the media manipulation to improve the quality of service provided.

The system may additionally include a network to which the end device and an additional end device are connected. In this case, the quality of service perceived by the user of the end device depends on media signals sent through the network by the additional end device, the software agent additionally issues instructions to the additional end device, and the system additionally includes a further software agent located in the additional end device to perform a bit rate control operation in response to the instructions issued by the software agent. The bit rate control operation improves the quality of service provided at the end device.

### BRIEF DESCRIPTION OF THE DRAWINGS

FIG. 1 shows one embodiment of a system according to the invention connected to a network.

FIG. 2 illustrates the agent structure and data flow in the system according to the invention.

FIG. 3 is a flow chart depicting operation of the invention.

FIG. 4 shows details of an example of the bit rate control processing executed by the software agent in the system according to the invention.

FIGS. 5A and 5B respectively show an example of a display before and after media synthesis and has been applied.

### DETAILED DESCRIPTION OF THE INVENTION

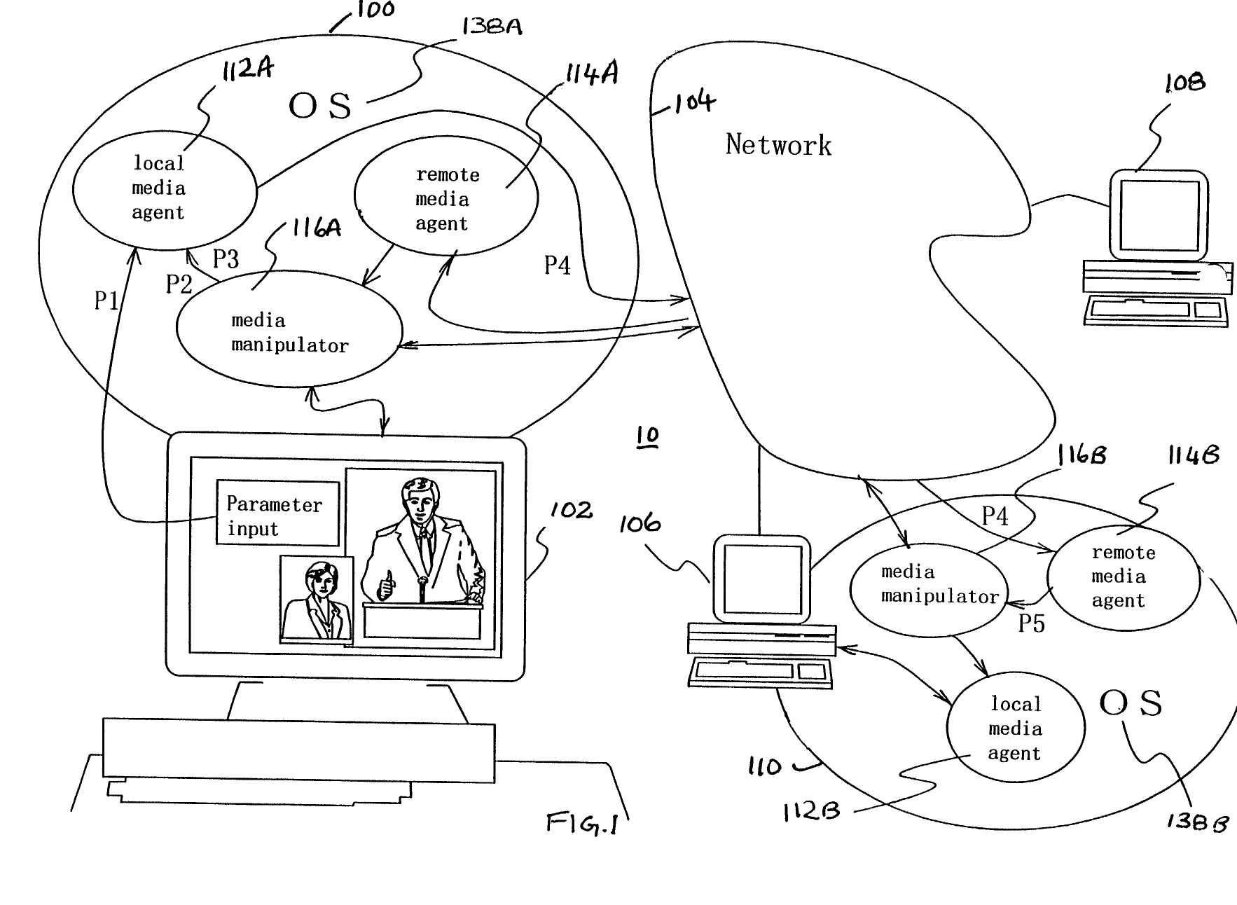

The invention will be described with reference to FIG. 1 which illustrates the invention as applied to a video conferencing system 10. Software agents, including a local media agent and a remote media agent, are located in the end devices connected to the network. These agents can be installed in the end devices by downloading them over the network. In each end device, a local media agent receives from the user of the end device parameters defining the user's video and audio quality demands and compares these parameters with parameters indicating the state of the video and audio processing performed by the end device. If the user's quality demands are not satisfied, the local media agent changes the allocated CPU time or the priority of the processes that determine the video and audio quality to increase the video and audio quality towards the user's video and audio quality demands. If no resources that can be used for this purpose remain available in the end device, the local media agent passes the parameters defining the user's quality demands to remote media agents located in the other end devices. Based on the parameters received, each of the remote media agents issues bit rate control instructions to a media manipulator in the same end device with the aim of providing the video and audio quality that meets the user's video and audio quality demands.

In a stand-alone end device, a local media agent acting alone performs a similar resource allocation operation ensure that the video and audio quality provided by the end device meets the user's quality demands.

FIG. 1 shows an example of the quality of service system 100 according to the invention installed in the end device 102 connected to the network 104. Other end devices, such as the end devices 106 and 108, are connected to the network. In this example, another example 110 of the quality of service system is installed in the end device 106. Corresponding elements of the quality of service systems 100 and 110 are indicated by the same reference numerals with the letters A and B added.

The quality of service system 100 will now be described. The quality of service system 110 is identical and so will not be described. The main structural elements of the quality of service system 100 are the agents installed in the end device 102, i.e., the local media agent 112A and the remote media agent 114A; and the media manipulator 116A that controls media manipulation by the end device 102. Media manipulation includes such operations as compressing or expanding signals representing video or audio information. In this example, the video and audio signals are received from the network. In an embodiment of the system installed in a stand-alone end device, the remote media agent may be omitted. The local media agent controls media manipulation in the end device 102 in response to video and audio quality demands made by the user of the end device 102. The remote media agent 114A controls media manipulation in the end device 102 in response to video and audio quality demands made by the users of the other end devices such as the end device 106.

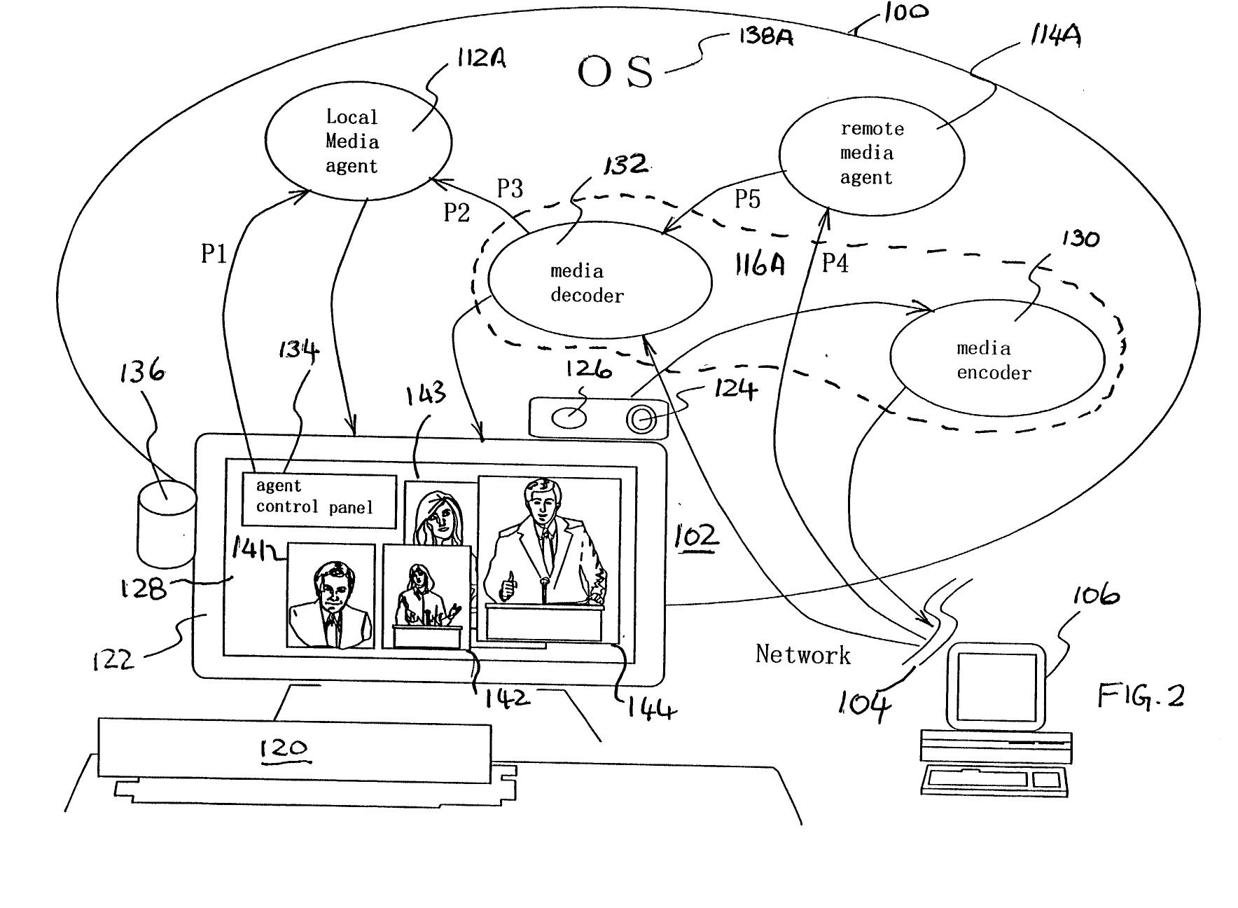

FIG. 2 shows in more detail the structure of the end device 102 and the flow of data and signals between the principal components of the end device and between the principal components of the end device and the network 104. The end device is based on the computer or workstation 120 that includes the monitor 122. The camera 124 and microphone 126 are located near the screen 128 of the monitor. The video and audio signals generated by the camera and microphone are compressed by the media encoder 130 for transmission to other end devices connected to the network 104. Video and audio signals received from the other end devices connected to the network are expanded by the media decoder 132 and the resulting uncompressed signals are displayed on the screen 128 and are reproduced by the loudspeaker 136. The media agents and other modules installed in the end device 102 interact with one another through the operating system depicted symbolically at 138A.

Part of the screen 128 is occupied by the agent control panel 134 by means of which the user enters or selects his or her video and audio quality demands. A keyboard or other external input device (not shown) may be used instead of or in conjunction with the agent control panel.

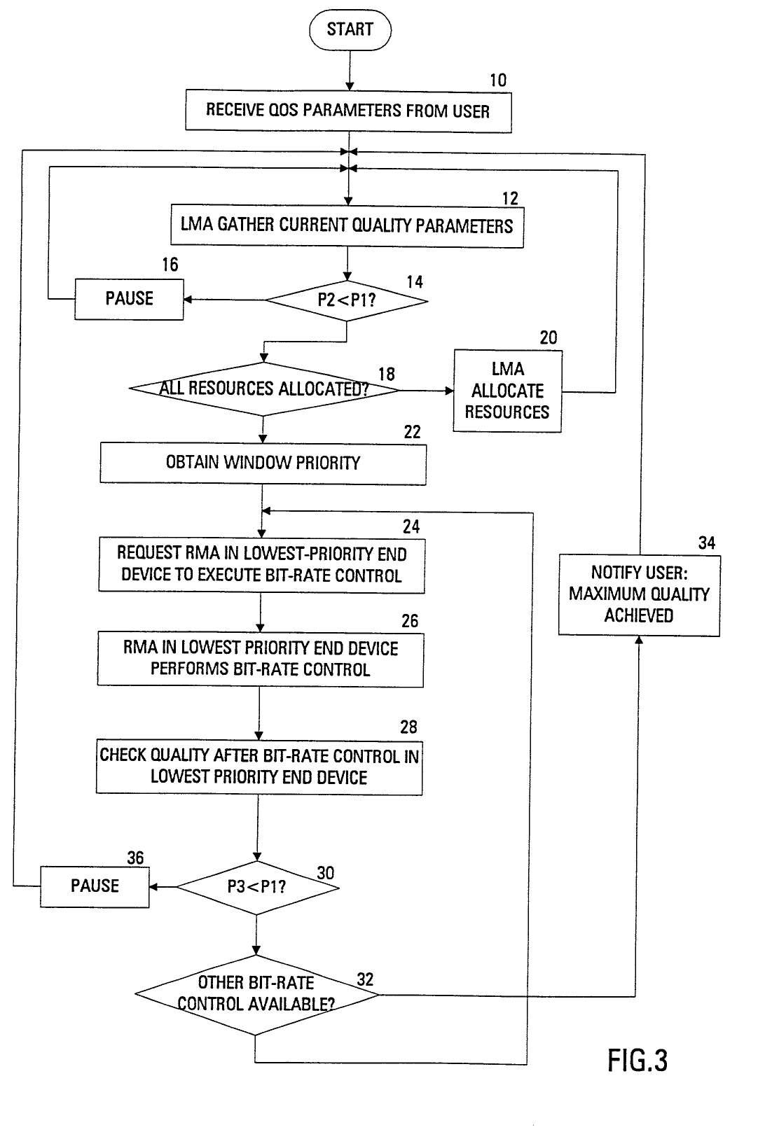

Operation of the system quality of service system 100 as applied to video conferencing will now be described with reference to the flow chart shown in FIG. 3 and the structural drawings shown in FIGS. 1 and 2. A practical embodiment of the system was tested using a personal computer running the Microsoft® Windows 95™ operating system. However, the system can easily be adapted to run on computers or workstations based on other operating systems.

In the video conferencing application, one or more windows, for example, the windows 141-144, are opened on the screen 128 of the end device 102. A video signal received from one of the other end devices connected to the network 104 is displayed in each of the windows.

In step 10, the system receives the quality of service parameters input by the user. The user uses the agent control panel 134 displayed on the screen 128 of the monitor 122 of the end device 102 to input parameters that define the user's video and audio quality demands. These parameters will be called quality of service (QOS) parameters. Specific examples of these parameters include the frame rate, the picture size, the audio bandwidth and number of quantizing levels. The QOS parameters input by the user are designated by P1. The agent control panel passes the QOS parameters input by the user to the local media agent (LMA) 112A. Next, the user makes the system settings (not shown) required for the video conference.

In step 12, the LMA 112A monitors the current quality of the pictures displayed on the screen 128 and the sound reproduced by the loudspeaker 136 of the end device 102. The LMA gathers from the media decoder 132 the current quality parameters P2 that indicate such quality factors as the frame rate, number of quantizing levels and picture size of the video signal currently displayed in each of the windows 141-144 and the audio bandwidth and number of quantizing levels of the corresponding sound channels.

At step 14, the LMA 112A performs a test to determine whether the current quality is inferior to the user's video and audio quality demands by determining whether P2 is less than P1. If the test result is NO, indicating that the current quality is as good as or better than the user's video and audio quality demands, execution passes to step 16. If the test result is YES, processing advances to step 18.

At step 16, execution pauses for a predetermined time. After the pause, execution returns to step 12 so that the LMA 112A can gather new current quality parameters. Even if the current video and audio quality meets the user's video and audio quality demands, internal conditions or network load conditions may change in a way that degrades the current video and audio quality to below the user's video and audio quality demands. To deal with this situation, the current video and audio quality must be repetitively tested with a defined period of time between successive tests, even when video and audio quality meeting the user's quality demands has been attained. The time period between successive tests of video and audio quality is set by the pause at step 16, which can be specified by the user.

At step 18, the LMA 112A performs a test to determine whether all of the dynamically-allocable resources available to the operating system 138A of the end device 102 have been allocated. If the test result is NO, and not all of such resources have been allocated, execution passes to step 20. If the test result is YES, and all of the dynamically-allocable resources have already been allocated, execution passes to step 22.

At step 20, the LMA 112A increases the allocation of the dynamically-allocable resources available to the operating system 138 of the end device 102 to video and audio processing with the purpose of improving the current video and audio quality. To achieve this increased allocation, the LMA may perform processing to cause the operating system 138A to increase the width of the slices of CPU time allocated to perform video and audio processing, or to assign a higher priority for the video and audio processing. This processing uses appropriate operating system calls to the operating system 138A. After step 20 has been completed, execution returns to step 12 to allow a determination of whether the increased allocation of dynamically-allocable resources made at step 20 has been successful in improving the current video and audio quality to a level that meets the user's video and audio quality demands.

Step 22 is executed when the end device 102 lacks further dynamically-allocable resources that can be allocated to improve the current video and audio quality. At step 22, the LMA asks the user to establish a relative quality priority to each of the windows displayed on the screen 128 of the monitor 122. This query is made, and the user's response is received, using the agent control panel 134 displayed on the screen 128. Once a quality priority for each of the windows has been received from the user, execution passes to step 24.

At step 24, the LMA contacts the remote media agent (RMA) in the end device that generates the video signal displayed in the window indicated by the user input received at step 22 to have the lowest priority and issues a bit rate control request to this RMA. For example, if the end device that generates video signal displayed in the lowest-priority window is the end device 106, the LMA 112A contacts and issues a bit-rate control request P4 to the RMA 114B, as shown in FIG. 1. The bit-rate control request specifies such parameters as the number of quantizing levels applied to the video signal, the frame rate of the video signal, the picture size of the video signal, bandwidth and number of quantizing bits of the audio signal, and the video compounding state of the video signal. The bit rate control request additionally includes data specifying the minimum required quantity of the video and audio signals demanded by the user from that end device. The bit rate control request is indicated by the data P4 in FIG. 1. A bit rate control request sent to the remote media agent 114A in the end device 102 is indicated by P4 in FIG. 2.

In step 22, the user can additionally specify a waiting time for the LMA. The waiting time defines the time that must elapse before the LMA issues a bit rate control request to the RMA. This waiting time prevents the LMA from issuing an unnecessary bit rate control request to one or more of the RMAs in the event of a temporary system overload, for example.

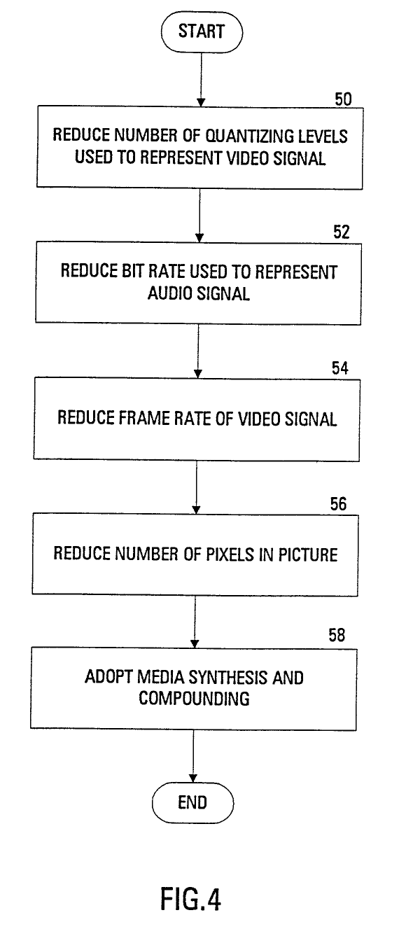

At step 26, the RMA of the end device that generates the video and audio signals having the lowest priority instructs the media manipulator in that end device to perform a bit rate control operation according to a pre-assigned algorithm. In the example shown in FIG. 1, the RMA 114B in the end device 106 instructs the media manipulator 116B in that end device to perform a bit rate control operation according to a pre-assigned algorithm. The control data are indicated by P5 in FIG. 1. An example of how such bit rate control can be achieved will be described below with reference to FIG. 4.

At step 28, the LMA 112A monitors the new quality of the pictures displayed on the screen 128 and of the sound reproduced by the loudspeaker 136 of the end device 102. The LMA gathers from the media decoder 132 the new quality parameters P3 that indicate such quality factors as the frame rate, number of quantizing levels and picture size of the video signal currently displayed in each of the windows 141-144 and the audio bandwidth and number of quantizing levels of the corresponding sound channels.

At step 30, the LMA 112A performs a test to determine whether the new video and audio quality is inferior to the user's video and audio quality demands by determining whether P3 is less than P1. If the test result is YES, execution passes to step 32. If the test result is NO, execution advances to step 36.

At step 32, if the user's video and audio quality demands are not satisfied by the bit rate control step performed by the RMA in the end device 106, then the LMA 112A again checks the window priorities entered by the user to determine whether other end devices have the potential to perform bit rate control operations. If such other end devices exist, execution passes to step 24. If all of the end devices have performed a bit rate control operation, and the bit rate control possibilities have therefore been exhausted, execution passes to step 34.

At step 34, the LMA informs the user that all the video and audio quality improvement possibilities have been exhausted by posting a notice on the screen 128.

At step 36, execution pauses for a predetermined time. After the pause, execution returns to step 12 so that the LMA 112 A can gather new current video and audio quality parameters. Execution pauses and returns to step 12 for the same reasons as those described above with reference to step 16.

Although operation of the end device 102 as a receiving device was just described, since communication between the end device 102 and the other end devices, such as the end devices 106 and 108, is bidirectional, the end device 102 additionally operates as a transmitting device, and may perform bit-rate control operations in response to requests issued by such other end devices.

FIG. 4 is a flow diagram showing how bit rate control is performed in the end devices. In practical bit rate control, the order of the steps is not critical, and may be freely changed by the user depending on the user's priorities. Moreover, bit rate control measures in addition to those that will be described with reference to FIG. 4 can additionally be applied.

At step 50, the number of quantizing levels applied to quantize the transform coefficients resulting from the discrete cosine transforms (DCT) applied to the video signal is reduced. This reduces the bit rate required to represent the picture at the expense of making the picture appear coarser.

At step 52 the bit rate of the audio signal is reduced by reducing the number of bits allocated to represent the audio signal. This reduces the bit rate at the expense of reduced audio quality or a reduction in the audio bandwidth.

At step 54, the frame rate of the video signal is reduced. This reduces the bit rate at the expense of a reduction in the smoothness with which moving pictures are presented.

At step 56, the picture size, i.e., the number of pixels in the horizontal and vertical directions, is reduced. This reduces the bit rate at the expense of reducing the picture size. Alternatively, the bit rate may be reduced by changing from a common intermediate format (CIF) to quarter common intermediate format (QCIF), which reduces the picture size to one-fourth.

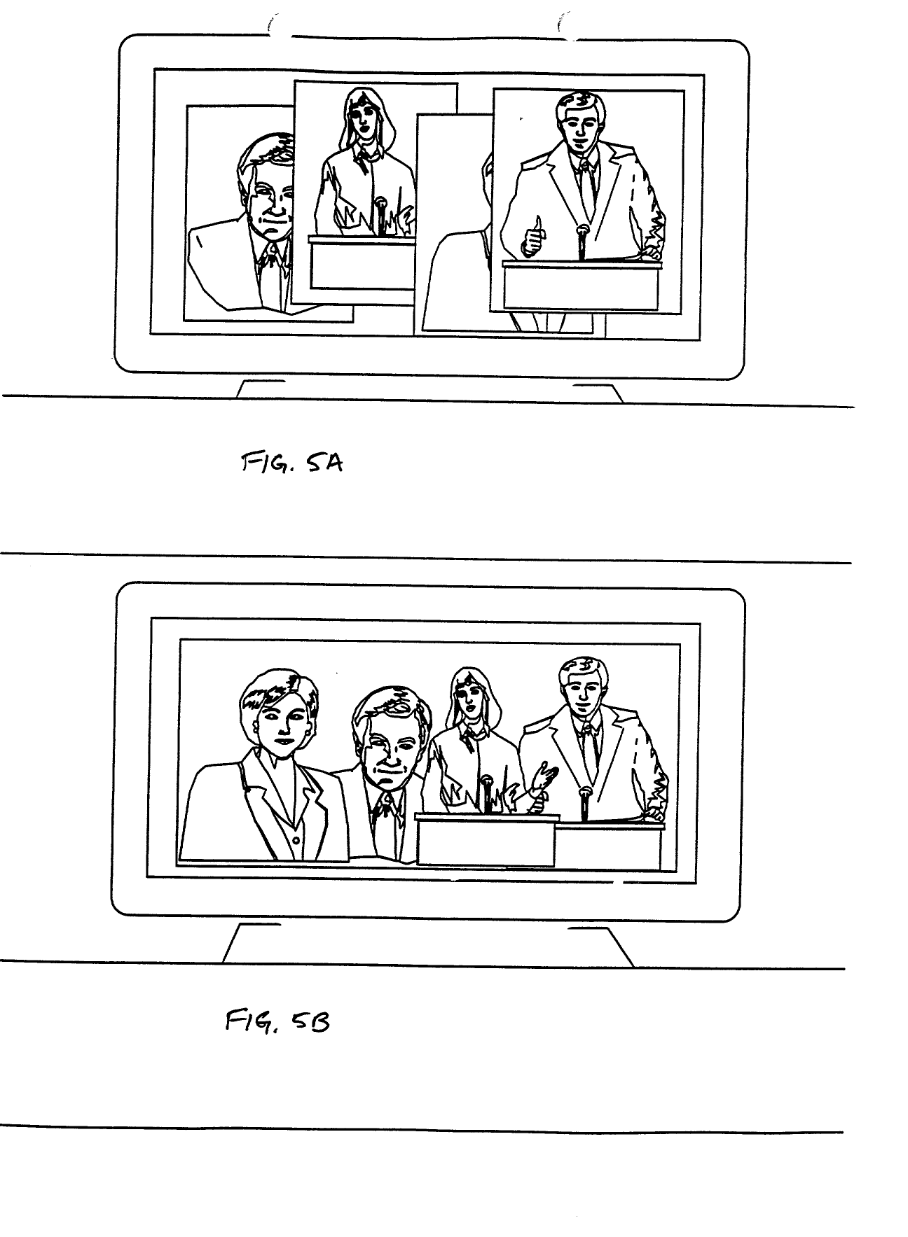

At step 58, a technique called media synthesis and compounding is adopted. Normally, each end device connected to the network receives a bitstream representing a video signal and an audio signal from each of the other active end devices connected to the network. The end device individually decodes each video bitstream and each audio bitstream to recover the video signal and the audio signal. The monitor of the end device displays the video signal from each of the other active end devices in an individual window, as shown in FIG. 5A. The audio signals are mixed and reproduced by a loudspeaker.

Media synthesis and compounding reduces the processing that has to be performed by all but one of the end devices connected to the network. Each end device connected to the network places a bitstream representing a video and audio signal onto the network. A multipoint control unit (MCU) receives these bitstreams from the network, decodes the bitstreams to provide corresponding video and audio signals, synthesizes the video signals to generate a single, compound video signal and synthesizes the audio signals to generate a single, compound audio signal. The MCU then generates a single, compound bitstream representing the compound video signal and the single audio signal and places this bitstream on the network. The end devices connected to the network can select the single, compound bitstream generated by the MCU instead of the bitstreams generated by the other end devices. Consequently, the end devices need only decode the single compound bitstream to be able display the video signals generated by the other end devices, and to be able to reproduce the audio generated by the other end devices. FIG. 5B shows an example of the appearance of the screen after media synthesis and compounding has been applied.

Media synthesis and compounding can be applied progressively. The compound bitstream can be generated from the video and audio signals generated by fewer than all of the active end devices connected to the network. The bitstreams representing the video and audio signals generated by the remaining active end devices can be individually received and decoded, and the decoded video signals displayed in individual windows overlaid on the video signal decoded from the compound bitstream. This requires more processing than when only the compound bitstream is decoded, but requires less processing than when the bitstream from each end device is individually decoded. If the resources available for media processing are reduced for some reason, such as the need to provide resources to perform other tasks, the number of the end devices whose video and audio signals are subject to media synthesis and compounding can be increased, and the number of end devices whose bitstreams are individually decoded can be reduced to enable the user's video and audio quality demands to be met with the reduced resources.

To provide optimum video and audio quality, the MCU that performs the media synthesis and compounding should preferably be located in an end device that performs relatively few other tasks. MCUs may be located in more than one of the end devices connected to the network, but only one of them performs media synthesis and compounding at a time. This enables the location of the MCU that performs the media synthesis and compounding to be changed dynamically in response to changes in the task loads on the end devices that include the MCUs. Alternatively, the MCU may be embodied in a stand-alone server connected to the network.

The invention improves video and audio quality and optimizes the use of the CPU's dynamically-allocable resources in the end device without the need to add special hardware. In addition, the invention provides these advantages in a standalone, non-networked device. Before the invention, competing non-real time applications could monopolize, or share inappropriately, the dynamically-allocable resources of the end device and thus prevent satisfactory video and audio quality from being attained. Moreover, when the end device has insufficient dynamically-allocable resources, the video and audio quality can be optimized using bit rate control operations performed in response to the user's allocation of viewing and listening priorities.

During a video conference, the invention enables such resources as are required to provide the quality of service demanded by the user to be assigned to the video conference even though the end device is performing other tasks. Since the remaining resources of the end device can be allocated dynamically to performing other tasks, the dynamically-allocable resources of the end device can be used optimally. Furthermore, this allocation is visible to the user and can be configured by the user.

Since the invention may be implemented by installing software agents in the end devices, special hardware is not needed. Such software agents can be installed in the end devices by downloading them from the network.

Although the invention has been described with reference to an embodiment in which video and audio quality that meets the user's video and audio quality demands is provided, the invention may alternatively be used to provide video quality that meets the user's video quality demands, or audio quality that meets the user's audio quality demands.

Although this disclosure describes illustrative embodiments of the invention in detail, it is to be understood that the invention is not limited to the precise embodiments described, and that various modifications may be practiced within the scope of the invention defined by the appended claims.

We claim:

1. A method of controlling an end device that includes an operating system that controls media manipulation to provide a quality of service specified by a user, the method comprising:
receiving an input specifying a demand for a quality of service;
monitoring a quality of service provided to determine whether the quality of service provided meets the quality of service demanded; and
when the quality of service provided is less than the quality of service demanded, using a software agent to assert dynamic control over the operating system to increase resources allocated to the media manipulation to improve the quality of service provided.

2. The method of claim 1, in which:
the end device is connected to a network to which an additional end device is connected;
the quality of service perceived by the user of the end device depends on media signals sent by the additional end device; and
the method additionally comprises:
using the software agent to issue instructions to the additional end device, and
using a further software agent located in the additional end device to perform a bit rate control operation in response to the instructions issued by the software agent, the bit rate control operation improving the quality of service at the end device.

3. The method of claim 2, in which:
the software agent additionally passes data indicating the quality of service demanded to the additional software agent; and
the additional software agent performs the bit rate control operation in response to the data indicating the quality of service demanded.

4. The method of claim 3, in which the additional software agent performs the bit rate control operation by causing the additional end device to change one of the following parameters of the media signal transmitted by the additional end device:
a number of quantizing levels applied to a video signal,
a frame rate of the video signal;
a picture size of the video signal;
bandwidth and number of quantizing bits of an audio signal; and
a media synthesis and compounding state of the video and audio signals.

5. The method of claim 2, in which:
more than one additional end device is connected to the network;
each additional end device transmits a media signal to the end device;
the quality of service perceived by the user of the end device depends on media signals sent by each additional end device; and
the method additionally comprises:
receiving a priority input assigning a priority to each additional end device,
using the software agent to issue instructions to an additional end device having a lowest one of the priorities assigned by the priority input.

6. The method of claim 1, in which the software agent causes the operating system to increase resources allocated to the media manipulation by one of:
changing a priority level of the media manipulation, and
increasing CPU time allocated to the media manipulation.

7. The method of claim 6, in which:
the end device is connected to a network to which an additional end device is connected;
the quality of service perceived by the user of the end device depends on media signals sent by the additional end device; and
the method additionally comprises:
using the software agent to issue instructions to the additional end device, and
using a further software agent located in the additional end device to perform a bit rate control operation in response to the instructions issued by the software agent, the bit rate control operation improving the quality of service at the end device.

8. The method of claim 7, in which:
the software agent additionally passes data indicating the quality of service demanded to the additional software agent; and
the additional software agent performs the bit rate control operation in response to the data indicating the quality of service demanded.

9. The method of claim 8, in which the additional software agent performs the bit rate control operation by causing the additional end device to change one of the following parameters of the media signal transmitted by the additional end device:
a number of quantizing levels applied to a video signal,
a frame rate of the video signal;
a picture size of the video signal;
bandwidth and number of quantizing bits of an audio signal; and
a media synthesis and compounding state of the video and audio signals.

10. The method of claim 8, in which:
more than one additional end device is connected to the network;
each additional end device transmits a media signal to the end device;
the quality of service perceived by the user of the end device depends on media signals sent by each additional end device; and
the method additionally comprises:
receiving a priority input assigning a priority to each additional end device,
using the software agent to issue instructions to an additional end device having a lowest one of the priorities assigned by the priority input.

11. A system including an end device adapted to provide a quality of service specified by a user, the end device comprising:
an operating system;
resources operating in response to the operating system to perform tasks including media manipulation;
an input device configured to receive parameters specifying a demand for a quality of service;
a quality of service monitor that monitors a quality of service provided to determine whether the quality of service provided meets the quality of service demanded; and
a software agent that operates in response to the quality of service monitor and that, when the quality of service provided is less than the quality of service demanded, asserts dynamic process control over the operating system to increase an allocation of the resources to performing the media manipulation to improve the quality of service provided.

12. The system of claim 11, in which:
the system additionally includes a network to which the end device and an additional end device are connected;
the quality of service perceived by the user of the end device depends on media signals sent through the network by the additional end device; and
the software agent additionally issues instructions to the additional end device, and
the system additionally includes a further software agent located in the additional end device to perform a bit rate control operation in response to the instructions issued by the software agent, the bit rate control operation improving the quality of service at the end device.

13. The system of claim 12, in which:
the software agent additionally passes parameters indicating the quality of service demanded to the additional software agent; and
the additional software agent performs the bit rate control operation in response to the parameters indicating the quality of service demanded.

14. The system of claim 13, in which the additional software agent performs the bit rate control operation by causing the additional end device to change one of the following parameters of the media signal transmitted by the additional end device:
a number of quantizing levels applied to a video signal,
a frame rate of the video signal;
a picture size of the video signal;
bandwidth and number of quantizing bits of an audio signal; and
a media synthesis and compounding state of the video and audio signals.

15. The system of claim 12, in which:
the system additionally includes more than one additional end device connected to the network;
each additional end device transmits a media signal to the end device through the network;
the quality of service perceived by the user of the end device depends on media signals sent by each additional end device;
the input device is additionally configured to receive a priority input assigning a priority to each additional end device;
the software agent additionally issues instructions through the network to an additional end device having a lowest one of the priorities assigned by the priority input.

16. The system of claim 11, in which the software agent causes the operating system to increase the allocation of the resources to performing the media manipulation by one of:
changing a priority level of the media manipulation; and
increasing CPU time allocated to the media manipulation.
